(19) United States
(12) Patent Application Publication
(10) Pub. No.: US 2015/0197185 A1
(43) Pub. Date: Jul. 16, 2015

(54) Vehicle Signaling Device

(71) Applicant: Bettye Jones, Los Angeles, CA (US)

(72) Inventor: Bettye Jones, Los Angeles, CA (US)

(21) Appl. No.: 14/597,042

(22) Filed: Jan. 14, 2015

Related U.S. Application Data
(60) Provisional application No. 61/927,117, filed on Jan. 14, 2014.

(51) Int. Cl. B60Q 1/50

(52) U.S. Cl. CPC B60Q 1/50

(57) ABSTRACT

A vehicle signaling device for expressing thanks or gratitude to another driver. The device includes a hand-shaped member pivotally attached to a housing and that is remotely controlled by the driver so as to move the hand-shaped member from side-to-side, in a waving motion. The device is preferably positioned adjacent to the rear windshield of a vehicle so that it is visible by drivers behind the user's vehicle. The hand-shaped member includes indicia thereon to express thanks and may include the phrase “thank you” or a similar phrase thereon. The hand-shaped member further includes lights that illuminate when the hand-shaped member is waving. Further, the hand-shaped member may be composed of a plurality of individual finger sections that can be folded into a collapsed configuration when not in use or that can be expanded into an extended configuration, wherein the individual finger sections resemble a hand.

### CROSS REFERENCE TO RELATED APPLICATION

This application claims the benefit of U.S. Provisional Application No. 61/927,117 filed on Jan. 14, 2014. The above identified patent application is herein incorporated by reference in its entirety to provide continuity of disclosure.

### BACKGROUND OF THE INVENTION

1. Field of the Invention

The present invention relates to vehicle signaling devices. More specifically, the present invention provides a vehicle signaling device adapted to be mounted adjacent to the rear windshield of an automobile. The device may resemble a hand and is movable side-to-side in a waving motion so as to express thanks to the driver of a vehicle behind a user. The device may further include lights thereon that illuminate when the device is in motion.

When driving an automobile, it is often desirable to express thanks or gratitude to another driver on the road. For example, when a first driver is trying to merge onto a road, a second driver on that road may yield to the first driver so as to allow the first driver to merge safely. Similarly, if multiple drivers are waiting at a stop sign and cannot determine who arrived first, one driver may signal for the other driver to proceed. The driver who was allowed to merge or the driver who was signaled to proceed first from the stop sign may wish to express gratitude to the other driver.

Generally, drivers wave their hand so as to express thanks to the other driver. However, when waving from inside of a vehicle, the other driver may not be able to see the driver's sign of appreciation or thanks. As a result, some drivers may become annoyed or angry if a driver fails to observe proper etiquette and signal or wave thank you to the driver. Thus, a device that allows a user to more clearly signal “thank you” to indicate the driver's gratitude to another driver is desired.

2. Description of the Prior Art

Devices have been disclosed in the prior art that relate to waving or gesturing devices. These include devices that have been patented and published in patent application publications. These devices generally relate to gesturing devices that wave back and forth for advertising or notification purposes. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 7,377,063 to Meyer discloses a hand gesture display device for vehicles. The device includes a box having a shaft rotatably mounted therein, wherein the shaft extends out of the box. Two primary indicia displays are mounted on opposite ends of the shaft and are in an upright position when the shaft is in the initial position. Two secondary indicia are mounted on the shaft and are displayed in an upright position when the shaft is rotated. Thus, while Meyer discloses a gesturing display device, Meyer fails to disclose a device having a hand-shaped member that is adapted to move side-to-side to mimic a waving motion in order to express gratitude to other drivers.

U.S. Pat. No. 2,714,266 to Jauquet discloses a moving arm for advertising purposes. The device includes an apparatus comprising an arm pivotally mounted and connected to a moving mechanism while a hand is pivotally mounted on the opposite end thereof. The hand preferably has its thumb bent to form a clamp so that the hand can hold a sign. Thus, Jauquet discloses a moving arm for advertising and fails to disclose a vehicle signaling device comprising a hand-shaped member to be positioned adjacent to a vehicle's rear windshield.

U.S. Pat. No. 2,817,916 to Yarrow discloses an electrically actuated oscillatory display device. The motion of an actuator is induced by alternate heating and cooling of a bi-metallic element. The display device includes a base having an actuator secured thereon and a movable display piece mounted on the actuator. Thus, Yarrow discloses an oscillating display device utilizing a bi-metallic element and does not disclose a vehicle signaling device adapted to mimic a waving motion to express gratitude to another driver.

U.S. Pat. No. 6,282,823 to Brown discloses a driver courtesy device comprising a control unit that can be secured to the dashboard of a vehicle, and a display unit mounted near the rear windshield of the vehicle. The display unit includes an upstanding member that resembles an arm and hand. By operating the control unit, the hand can be moved in a waving motion to convey a courtesy gesture. This device, however, fails to disclose the use of lights or indicia thereon to make it clear that the user intends to express gratitude, and to allow the device to be easily viewed in periods of low light.

U.S. Pat. No. 2,147,010 to Cranford discloses a vehicle signaling device for indicating a change in course of the vehicle. The device includes an arm pivotally mounted for movement between various positions. The device is concealed from view when in a non-signaling position, and is moved into view when used to provide a signal. Thus, Cranford fails to disclose a vehicle signaling device for use in expressing thanks to another driver, and fails to disclose indicia and lights on a hand member.

U.S. Design Patent Number D625,653 to De Felice discloses the ornamental design for a V-hand shaped display. The display includes a human hand having the index and middle fingers extended, while the ring finger, pinky finger, and thumb are folded into the palm. The hand displays what is commonly referred to as a “peace” sign. Thus, De Felice fails to disclose a vehicle signaling device that is adapted to move in a waving motion to express gratitude to other drivers.

Finally, Foreign Patent Document CN202413613 discloses a motor steered flexible hand device. The device comprises a motor, a rocking rod, and a simulation arm. The motor steered flexible hand device operates such that when a vehicle steers, a flexible hand waves continuously so as to warn pedestrians not to be close to the vehicle, helping to reduce traffic accidents. Thus, the invention fails to disclose a vehicle signaling device comprising a hand-shaped member adapted to be positioned adjacent the rear windshield of a vehicle, wherein the vehicle signaling device expresses gratitude to other drivers.

These prior art devices have several known drawbacks. The devices in the prior art generally relate to waving or hand-gesturing devices for drawing attention thereto. These devices, however, fail to provide a hand-shaped member adapted to be positioned adjacent the rear windshield of a vehicle, wherein the hand-shaped member waves back and forth to express thanks or gratitude to other drivers. Further, such devices lack indicia and illumination means thereon for drawing attention to the device and for clearly expressing gratitude to other drivers. Thus, the other devices do not provide drivers with a simple and convenient means for thanking other drivers while the user is driving a vehicle.

In light of the devices disclosed in the prior art, it is submitted that the present invention substantially diverges in design elements from the prior art and consequently it is clear that there is a need in the art for an improvement to existing vehicle signaling devices. In this regard the instant invention substantially fulfills these needs.

### SUMMARY OF THE INVENTION

In view of the foregoing disadvantages inherent in the known types of vehicle signaling devices now present in the prior art, the present invention provides a new vehicle signaling device wherein the same can be utilized for providing convenience for the user when expressing gratitude or thanks to another driver while driving a vehicle.

It is therefore an object of the present invention to provide a new and improved vehicle signaling device that has all of the advantages of the prior art and none of the disadvantages.

It is another object of the present invention to provide a vehicle signaling device that allows a driver of a vehicle to more easily express thanks or gratitude to another driver.

Another object of the present invention is to provide a vehicle signaling device comprising a hand-shaped device that is adapted to pivot side to side so as to mimic a waving motion.

Yet another object of the present invention is to provide a vehicle signaling device comprising a hand-shaped device having individual finger members than can be collapsed for storage and expanded during use.

Another object of the present invention is to provide a vehicle signaling device that can be remotely controlled by a driver of a vehicle.

A further object of the present invention is to provide a vehicle signaling device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an embodiment of the vehicle signaling device of the present invention.

FIG. 2 shows a view of an alternate embodiment of the vehicle signaling device of the present invention.

FIG. 3A shows a perspective view of an embodiment of the vehicle signaling device in a collapsed configuration.

FIG. 3B shows a perspective view of an embodiment of the vehicle signaling device in an extended configuration.

FIG. 4 shows a diagram of the operation of the vehicle signaling device of the present invention.

### DETAILED DESCRIPTION OF THE INVENTION

Reference is made herein to the attached drawings. Like reference numerals are used throughout the drawings to depict like or similar elements of the vehicle signaling device of the present invention. For the purposes of presenting a brief and clear description of the present invention, the preferred embodiment will be discussed as used for signaling. The figures are intended for representative purposes only and should not be considered to be limiting in any respect.

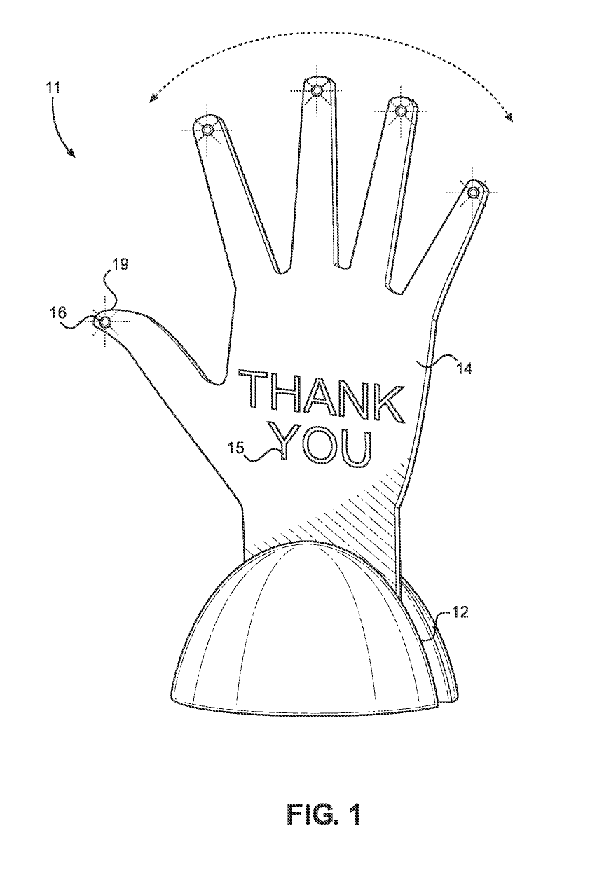

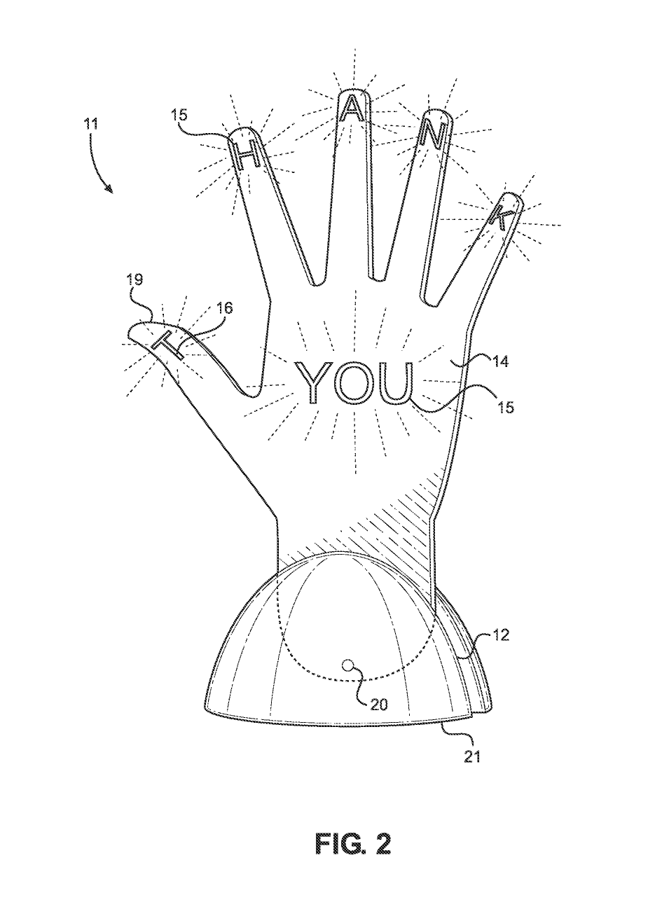

Referring now to FIGS. 1 and 2, there are shown views of exemplary embodiments of the vehicle signaling device of the present invention. The present invention comprises a hand-shaped member 14 that is substantially planar and that resembles a human hand. The hand-shaped member resembles a human hand having the fingers extended and separated from one another. The hand-shaped member 14 is preferably composed of a lightweight plastic material. The hand-shaped member 14 further includes one or more lights 16 thereon that illuminate when the device is activated so as to draw attention to the device 11. The lights 16 are preferably positioned on the palm or on the fingertips 19 of the hand-shaped member 14.

A surface of the hand-shaped member 14 includes indicia 15 thereon, wherein the indicia 15 preferably express thanks or gratitude. Such indicia 15 may include the phrase “thank you”, “thanks” or a similar variation thereof. The indicia 15 can be positioned on the palm portion of the hand-shaped member 14. Alternatively, each fingertip 19 of the hand-shaped member 14 can include a letter of the word “THANK” thereon, and the palm can include the word “YOU.” The indicia 15 can be inscribed on the hand-shaped member 14 in bright or reflective writing, or the indicia 15 can be composed of a plurality of lights 16 so that the text of the indicia 15 is illuminated.

The hand-shaped member 14 is pivotally mounted on a housing 12 that encloses a motor and a power source. In the illustrated embodiment, the housing 12 is substantially dome-shaped and includes a planar bottom surface for mounting onto a horizontal support surface. The motor is adapted to cause the hand-shaped member 14 to pivot side-to-side in a waving motion. In this way, the hand-shaped member 14 can be used to express thanks or gratitude to other drivers. The bottom end of the hand-shaped member 14 is positioned within the housing 12 and includes a pivot point 20 on which the hand-shaped member 14 rocks or moves side-to-side. The device 11 is preferably positioned adjacent to the rear windshield of a vehicle on the interior of the vehicle so that the hand-shaped member 14 is in a substantially upright position. In this way, the device 11 is easily visible to drivers of vehicles behind the user's vehicle.

The hand-shaped member 14 is remotely operated by means of a control unit that can be carried by the user or installed on the vehicle dashboard or steering wheel. The control unit includes a control switch that, when actuated, causes the hand to illuminate and/or wave for a predetermined period of time. The control unit preferably wirelessly communicates with the hand-shaped member 14, though in alternate embodiments it may be physically connected thereto by electrical cables.

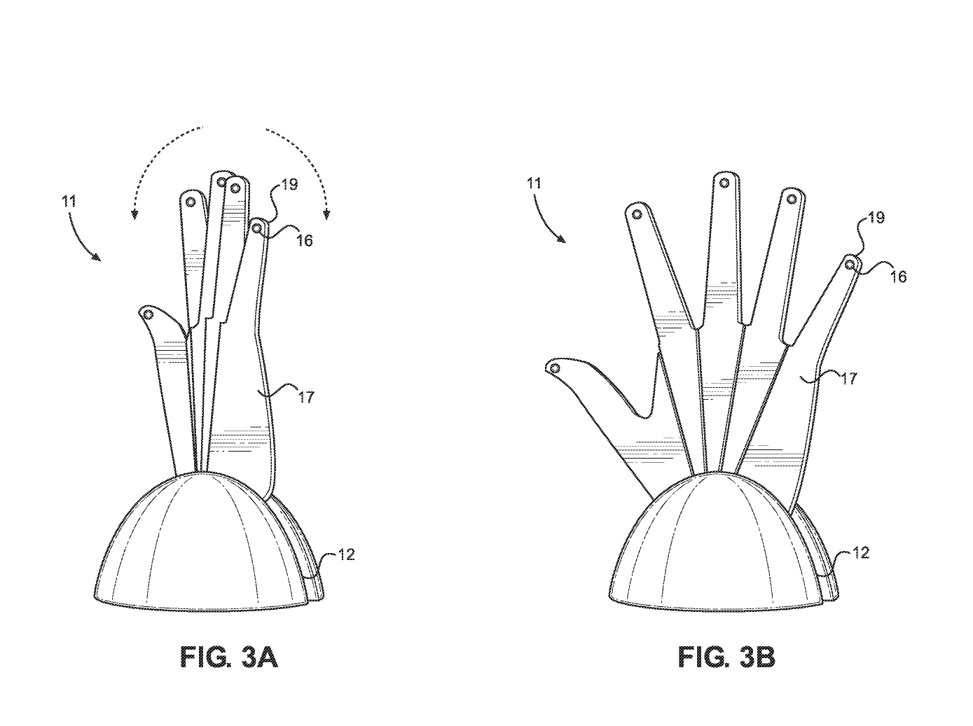

Referring now to FIGS. 3A and 3B, there are shown perspective views of an embodiment of the vehicle signaling device in a collapsed configuration and in an expanded configuration, respectively. In some embodiments of the present invention, the hand-shaped member is composed of a plurality of individual and separate finger sections 17. Preferably, there are five finger sections 17 corresponding to the fingers and thumb of a hand. The finger sections 17 are each pivotally connected to the housing 12. When the device is not in use, the finger sections 17 are collapsed in an overlapping configuration for storage. When the device is in use, the finger sections 17 are adapted to expand outward so that the finger sections 17 are arranged to resemble a human hand as shown in FIG. 3B.

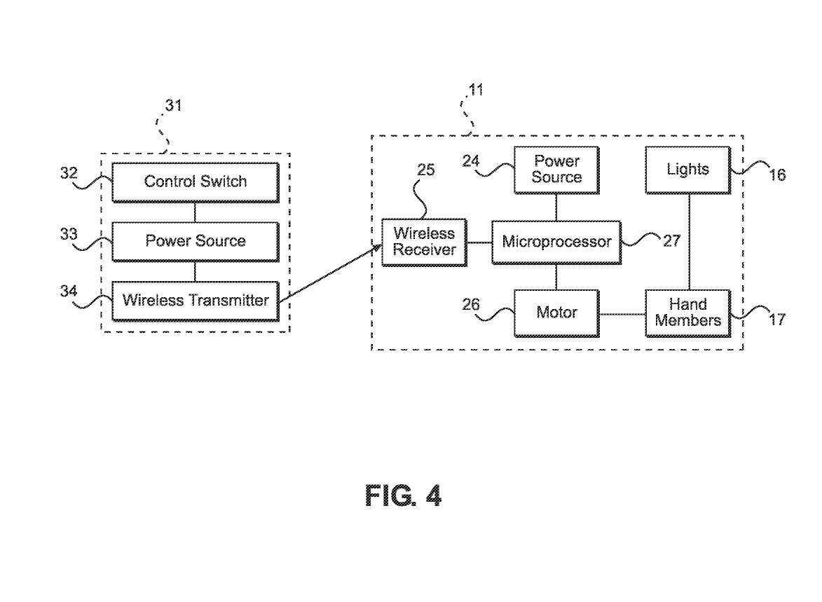

Referring now to FIG. 4, there is shown a diagram of the operation of the vehicle signaling device of the present invention. In operation, the user can utilize a control unit 31 that can be positioned on the dashboard of a vehicle, or that can be a key fob type of device. The control unit 31 includes a power source 33, such as one or more batteries therein, for powering the control unit 31. Alternatively, the control unit 31 can be integral to the vehicle's dashboard control system and powered via the vehicle's electrical system. The user can operate a control switch 32 on the control unit 31 that causes the wireless transmitter 34 therein to send a signal to the vehicle signaling device 11. In one embodiment, the control unit 31 comprises a single control switch 32 for actuating the motor 26 and the lights 16 simultaneously. In an alternate embodiment, the control unit 31 comprises a first control switch for actuating the motor 26 and a second control switch for actuating the lights 16 on the hand-shaped member.

A wireless receiver 25 is positioned within the housing 12 of the vehicle signaling device 11 and is adapted to receive a signal from the wireless transmitter 34. The vehicle signaling device 11 further comprises a microprocessor 27 adapted to cause the lights on the hand-shaped member to illuminate and/or to activate the motor 26, causing the hand to wave back and forth for a predetermined period of time. The motor 26 and lights are powered by a power source 24, such as one or more batteries. Further, in embodiments having several finger sections 17, the motor 26 causes the finger sections 17 to expand from a collapsed position into a configuration resembling a human hand prior to beginning the waving motion. Once the hand-shaped member has waved for a predetermined period of time, the finger sections 17 collapse into a stored configuration and the lights 16 thereon turn off. In this way, the present invention helps to prevent obstructing the driver's view of the rear windshield.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A vehicle signaling device for expressing gratitude to other drivers, comprising:
a hand-shaped member pivotally disposed on a housing;
said hand-shaped member being substantially planar and including indicia thereon adapted to express gratitude;
said housing enclosing a motor operably connected to said hand-shaped member and adapted to cause said hand-shaped member to move back and forth in a waving motion for a predetermined period of time when a control unit is actuated by a user;
said control unit comprising a control switch adapted to allow a user to control operation of said hand-shaped member.

2. The vehicle signaling device of claim 1, wherein said indicia includes the phrase “THANK YOU.”

3. The vehicle signaling device of claim 1, wherein said indicia is positioned on a palm portion of said hand-shaped member.

4. The vehicle signaling device of claim 1, wherein said indicia is positioned on each finger of said hand-shaped member and on a palm portion thereof.

5. The vehicle signaling device of claim 1, wherein said hand-shaped member further includes one or more lights thereon adapted to illuminate when said control switch on said control unit is activated.

6. The vehicle signaling device of claim 1, wherein said hand-shaped member comprises a plurality of individual finger sections adapted to be arranged in an overlapped configuration for storage, and adapted to be expanded so as to resemble a human hand.

7. The vehicle signaling device of claim 1, wherein said control unit further comprises a wireless signal transmitter adapted to communicate with a wireless signal receiver in said housing for wirelessly controlling the operation of said hand-shaped member.

8. The vehicle signaling device of claim 1, wherein said housing further comprises a microprocessor adapted to control the duration of said waving motion of said hand-shaped member.

9. The vehicle signaling device of claim 1, wherein said housing comprises a flat base such that said housing is adapted to be positioned adjacent to a rear windshield of a vehicle such that said hand-shaped member is in a substantially upright configuration.
